(19) United States
(12) Patent Application Publication
(10) Pub. No.: US 2022/0055131 A1
(43) Pub. Date: Feb. 24, 2022

(54) Chase With a Lead

(71) Applicant: Michael Steven Barth, Bernards TWP, NJ (US)

(72) Inventors: Michael Alexander Barth, Bernards TWP, NJ (US); Michael Steven Barth, Bernards TWP, NJ (US)

(21) Appl. No.: 16/974,424

(22) Filed: Jan. 28, 2021

Related U.S. Application Data
(60) Provisional application No. 62/974,475, filed on Nov. 30, 2019.

(51) Int. Cl. B23G 5/06; B23G 9/00

(52) U.S. Cl. CPC B23G 5/06; B23G 9/009

(57) ABSTRACT

This invention, a thread chase with a lead that acts as a smooth bore guide into a threaded hole is suitable where space is confined, and the male thread chase must be exactly aligned with the female threads, “sight unseen”, or damage to female threads may result by applying force to a misaligned thread chase, particularly where the female threads are of softer metals. The lead smooth bore also prevents shavings and other debris resulting from the cleaning from the chase, from falling into the hole that is being cleaned. A recessed tapered area between the threaded portion of this case and the lead smooth bore guide collects the shavings or cleaning residue so that when the tool is withdrawn from the hole, the shavings and cleaning residual will collect in that area and not fall into the threaded hole being cleaned.

### CROSS-REFERENCE TO RELATED APPLICATIONS

The present application is related to, and claims priority to and the benefits of U.S. provisional patent application Ser. No. 62/974,475 filed Nov. 30, 2019.

### BACKGROUND OF THE INVENTION

The present invention was initially made to solve a problem where access was very limited in replacing spark plugs on an older automobile. In this combustion engine car, the spark plugs screwed into threads in aluminum heads. Because of age, heating and cooling of the engine, deposits built-up on the female threads in the head, making it basically impossible to get new spark plugs started by hand. If force was applied to the sparkplugs by a ratchet or another tools to screw the sparkplug into the head, because there was no room in the engine compartment to properly use these tools, even a small amount of force to a misaligned spark plug could damage or cross thread the aluminum female threads in the head. No commercially available taps, or tap like thread chases, while having good cutting capabilities, where found to have sufficient aligning features, and as a result actually created a greater risk, through their use in a tight space, of stripping or cross threading the threads in the head through their use when not aligned between the male threads of the chase, and the female aluminum threads in the engine head. In addition, when these other tools without leads or guides cut the threads, they created a risk that shavings and other damaging material could fall into an engine chamber. While generic taps and thread chasers have been around for decades in the United States, heretofore, there does not appear to be a tool available with the necessary features that this new invention provides.

### BRIEF DESCRIPTION OF THE DRAWINGS

The drawings constitute a part of this specification of the subject matter sought to be protected and the accompanying drawings being an embodiment thereof, and following descriptions, so that the advantages should be readily understood and appreciated of the subject matter sought to be protected

FIG. 1 is a perspective view of an embodiment of the thread Chase with a Lead;

FIG. 2 is a right side elevation, a left side elevation view being a mirror image of the embodiment of the thread chase with a lead of FIG. 1;

FIG. 3 is a front elevation view, a rear elevation being a mirror image of the embodiment of the thread chase with a lead of FIG. 1;

FIG. 4 is a top plan view of the embodiment of the thread chase with a lead of FIG. 1;

FIG. 5 is a bottom plan view of the embodiment of the thread chase with a lead of FIG. 1;

### DETAILED DESCRIPTION OF THE EMBODIMENTS

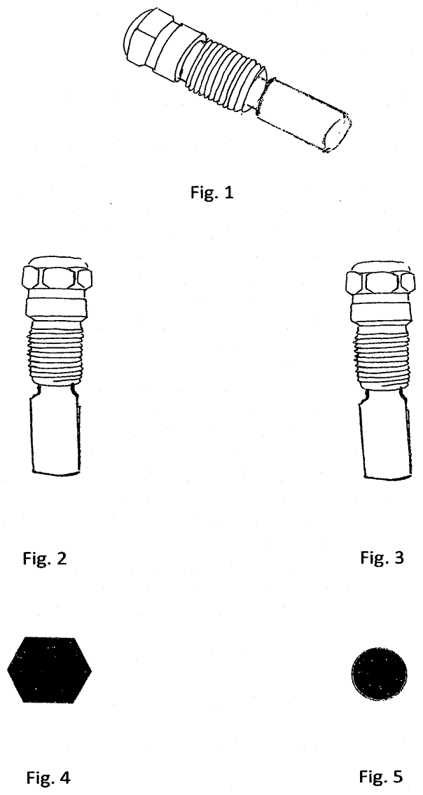

While this thread chase with a lead invention has embodiments in different forms and sizes, referring to FIGS. 1 through 5 as an embodiment of the thread chase with a lead, the smooth bore aspects of FIGS. 1 through 3 serve as the guide to align the threaded portion of the chase, so that when turning pressure is applied to turn the chase, because the chase is aligned, damage will not result to the female threads being cleaned or cut.

The smooth bore in FIGS. 1-3 prevent shavings and other debris from falling inₜo the hole of the threads to be cleaned or cut.

The recessed tapered area between the threads and the smooth bore in FIGS. 1-3 is designed to capture the shavings or debris from the thread chase.

FIG. 4 as a top view is to show that another tool can be attached to turn the thread chase with the lead.

FIG. 5 as a bottom view is to show the bottom of the lead portion that can be inserted into the round hole where the threads are to be cleaned or cut.

A tool, comprising:

1. A Thread chase with a lead that has a sufficient smooth bore to guide and align the thread cutting and thread cleaning functions of the male thread chase through female threads.

2. The thread chase with a lead tool of claim 1 wherein said tool has a sufficient smooth bore lead to prevent residual and shavings type material from falling into the female threaded chamber resulting from the cutting and clean functions of the male thread chase through the female threads.

3. The thread chase with a lead tool of claim I wherein said tool has a sufficient tapered recessed area between the male thread chase and the lead guide small bore to catch any residual and shavings type material from falling into the female threaded chamber resulting from the cutting and clean functions of the male thread chase through the female threads
